(19) United States
(12) Patent Application Publication
(10) Pub. No.: US 2006/0115757 A1
(43) Pub. Date: Jun. 1, 2006

(54) Toner for development of electrostatic latent image, electrostatic latent image developer, and method for formation of image

(75) Inventors: Emi Takahashi, Minamiashigara-shi (JP); Noriyoshi Takahashi, Minamiashigara-shi (JP); Sueko Sakai, Minamiashigara-shi (JP); Teruo Sakai, Minamiashigara-shi (JP); Tetsu Torigoe, Minamiashigara-shi (JP); Teigen Ri, Songpa-Gu (KR)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 11/137,383

(22) Filed: May 26, 2005

(30) Foreign Application Priority Data
Nov. 26, 2004 (JP) 2004-341993

(51) Int. Cl. G03G 9/087

(52) U.S. Cl. 430/109.3; 430/111.4; 430/108.1; 430/108.6; 430/108.7; 430/124

(57) ABSTRACT

A toner for development of an electrostatic latent image, comprises: a binder resin; a colorant; and a release agent, wherein the binder resin has a weight average molecular weight of 20,000 to 40,000, and when a carbon content and a sulfur content of the toner measured using X-ray fluorescence are represented by [C] % and [S] %, respectively, [S]/[C] satisfies expression (1):
0.0002≦[S]/[C]≦0.0030 (1).

### BACKGROUND OF THE INVENTION

1. Field of the Invention

The present invention relates to an image forming method for obtaining a preferred image by rendering visible an electrostatic latent image, which is formed using an electrophotographic method, an electrographic recording method or the like, by means of development, transfer and fixation.

2. Description of the Related Art

A method for rendering visible an image via an electrostatic image, such as electrophotography or the like, is currently utilized in various fields. In electrophotography, an electrostatic latent image is formed on a photoreceptor by charging and exposure steps. The electrostatic latent image is developed with a developer containing a toner, and then rendered visible by means of transferring and fixing steps.

The developer used therein includes a dual-component developer composed of a toner and a carrier and a monocomponent developer employing a magnetic or non-magnetic toner singly. These developers are prepared typically using a kneading-pulverization method, in which a thermoplastic resin is melt-kneaded with a pigment, a charge control agent and a release agent (e.g., wax, etc.), and after cooling, the resultant mixture is finely pulverized, followed by classification. An organic or inorganic microparticle may be optionally added to the surface of the toner particle in order to improve the fluidity or cleaning property thereof.

In recent years, copiers, printers, multifunction machines with copier and printer, and the like which employ a color electrophotographic method have become widespread. A polymerization toner is becoming widespread for the purpose of high image quality in color image reproduction. The polymerization toner can enclose a release agent, thereby allowing oilless fixation, which is difficult to achieve with the conventional kneading-pulverization method. Therefore, it is no longer necessary to apply a large amount of oil onto a fixing roll in order to assist release. Further, it becomes possible to avoid a sticky sense of a copied image (e.g., in the case of an OHP sheet) and write on the image using a pen or the like. Furthermore, it becomes possible to obtain an image having a uniform gloss.

Japanese Unexamined Patent Publication No. S63-282752 and Japanese Unexamined Patent Publication No. H06-250439 propose a method of producing a toner by an emulsion polymerization and aggregation method as a means which allows an intentional control of the shape and surface structure of a toner. Specifically, the method generally comprises preparing a resin dispersion solution by emulsion polymerization or the like, preparing a colorant dispersion solution by dispersing a colorant in a solvent, mixing these dispersion solutions to form an aggregate having a toner particle diameter, and fusing the aggregate by heating to obtain a toner. When these production methods are used, it is significantly important to design a property of the resin in order to achieve higher image quality. In the production methods, it is possible to enclose wax and easily obtain a small toner diameter, thereby allowing reproduction of an image having a higher level of resolution and sharpness. However, the release agent does not sufficiently seep out onto the surface of a fixed image, leaving a problem with the stability of release ability.

Japanese Unexamined Patent Publication No. 2001-75304 and Japanese Unexamined Patent Publication No. 2004-233983 describe a method of extending a temperature region in which a toner can be fixed. In Japanese Unexamined Patent Publication No. 2001-75304, an appropriate viscoelasticity and molecular weight peak of a toner are defined. In Japanese Unexamined Patent Publication No. 2004-233983, a portion of a binder resin has an epoxy group. According to these methods, by increasing the viscosity of the binder resin so that the viscosity is kept high even in a high temperature region, hot offset is prevented. However, the methods are not sufficient for fixation of a high-gloss full-color image.

Further, there is a recent problem called halftone offset. This is an offset phenomenon which occurs in an image having a small toner amount per unit area. The phenomenon occurs in a lower temperature region than in the related-art toner images having a large toner amount per unit area.

The toners of Japanese Unexamined Patent Publication No. 2001-75304 and Japanese Unexamined Patent Publication No. 2004-233983 described above are not sufficiently effective to solve the problem. Japanese Unexamined Patent Publication No. 2004-163584 describes a method of increasing the amount of a polymerization degree adjusting agent to have a balance with the weight average molecular weight. However, this method is not effective for the offset in a halftone portion.

### SUMMARY OF THE INVENTION

The present invention solves the above-described problems.

Specifically, the present invention provides a toner for the development of an electrostatic latent image, which employs an oilless fixation system and has a broad fixation temperature region. Further, the present invention provides a toner for the development of an electrostatic latent image, which can suppress the occurrence of hot offset even in an image in which a solid portion and a halftone portion coexist.

Furthermore, the present invention provides a developer comprising a toner for the development of an electrostatic latent image, a method of producing the toner for the development of an electrostatic latent image, and a method of forming an image using the toner for the development of an electrostatic latent image.

The above-described problems were solved by a toner for the development of an electrostatic latent image, which is described in (1) below with preferred embodiments (2) to (8) thereof.

(1) A toner for the development of an electrostatic latent image, comprising: a binder resin; a colorant; and a release agent, wherein the binder resin has a weight average molecular weight of 20,000 to 40,000, and when a carbon content and a sulfur content of the toner measured using X-ray fluorescence are represented by [C] % and [S] %, respectively, [S]/[C] satisfies expression (1):
0.0002≦[S]/[C]≦0.0030 (1).

(2) The toner for the development of an electrostatic latent image of (1), wherein the binder resin is a resin obtained by polymerization of a vinyl polymerizable monomer.

(3) The toner for the development of an electrostatic latent image of (1), further comprising an external additive on a surface of the toner, wherein the external additive comprises a resin microparticle having a weight average molecular weight of 100,000 or more and 500,000 or less.

(4) The toner for the development of an electrostatic latent image of any one of (1), comprising an external additive on a surface of the toner, wherein the toner has at least one of silica, aluminium oxide and titanium oxide as the external additive.

(5) The toner for the development of an electrostatic latent image of (1), wherein the external additive has a charge characteristic whose polarity is reverse to that of the toner.

(6) The toner for the development of an electrostatic latent image of any one of (1), wherein the toner has a shape factor SF1 of 115 to 130.

(7) The toner for the development of an electrostatic latent image of any one of (1), wherein the toner has a GSDp of 1.23 or less.

(8) The toner for the development of an electrostatic latent image of any one of (1), wherein the toner has a release agent content of 5 to 20% by weight.

Other problems are solved by a method of producing a toner for the development of an electrostatic latent image, a toner for the development of an electrostatic latent image, and a method of forming an image, which are described in (9), (10), and (11), respectively, with a preferred embodiment (12).

(9) A method of producing a toner for the development of an electrostatic latent image, comprising mixing at least a resin particle dispersion solution in which a resin particle having a particle diameter of 1 μm or less is dispersed and a colorant dispersion solution in which a colorant is dispersed to aggregate the binder resin particle and the colorant into a particle having a toner particle diameter, and heating the resultant aggregate particle to a temperature which is higher than or equal to a glass transition temperature of the binder resin particle so that the aggregate particle is fused to form a toner particle, wherein the binder resin has a weight average molecular weight of 20,000 to 40,000, and when a carbon content and a sulfur content of the toner which is obtained by causing a sulfur compound to coexist when preparing the resin particle dispersion solution are represented by [C] % and [S] %, respectively, as measured using X-ray fluorescence, [S]/[C] has the following relationship:
0.0002≦[S]/[C]≦0.0030 (2).

(10) An electrostatic latent developer comprising a carrier and the toner for the development of an electrostatic latent image of any one of (1).

(11) A method of forming an image, comprising charging a photoreceptor, exposing the charged photoreceptor to create a latent image on the photoreceptor, developing the latent image to create a developed image, transferring the developed image onto a fixing base material, and fixing the developed image on the fixing base material by heating using a fixing member, wherein the toner for the development of an electrostatic latent image of any one of (1) to (8) or the electrostatic latent image developer of (10) is used as a developer.

(12) The method of forming an image of (11), wherein a time for which the fixing member contacts the toner on the fixing base material is 0.02 to 0.1 sec.

### DETAILED DESCRIPTION OF THE INVENTION

Hereinafter, the present invention will be described in detail.

(Toner for Development of Electrostatic Image)

It is widely known that a toner for the development of an electrostatic latent image (hereinafter also simply referred to a “toner”) receives heat from a fixing member during fixation, so that the toner is melted and infiltrates a recording material (e.g., a paper sheet, etc.), resulting in fixation. In this case, if the temperature of the fixing member is low, the toner is not sufficiently melted, so that a toner layer adheres to the fixing member, i.e., a so-called cold offset phenomenon occurs.

If the temperature is excessively high, the toner is rapidly melted and the viscosity thereof is therefore lowered, so that the toner which directly contacts the fixing member adheres to the fixing member, i.e., a so-called hot offset phenomenon occurs. This phenomenon is likely to occur in an image in which a plurality of toner layers are stacked (e.g., a color toner, etc) and a color mixing ability or a color developing ability is required.

The reason why the hot offset is likely to occur in a fixed image of a halftone portion is not necessarily clearly understood, though the following mechanism is inferred.

In halftone portions, there is a small amount of toner per unit area. Therefore, it is inferred that the toner particles on a recording material are partially isolated individually or in groups of several particles. When a large amount of toner is placed on a recording material, the hot offset can be prevented due to the intermolecular force or aggregation force of resin molecules constituting the toner even if the viscosity of the toner is lowered in a high temperature region. However, it is inferred that, in the halftone portion, the force which attracts the toner to the fixing member is stronger than the intermolecular force or the aggregation force, and therefore, the offset phenomenon occurs.

The present inventors found that the control of the offset in a halftone portion is relevant to the amount of sulfur atoms contained in the toner, resulting in the completion of the present invention.

Specifically, the toner for the development of an electrostatic latent image according to the present invention, comprises a binder resin, a colorant and a release agent, wherein the binder resin has a weight average molecular weight of 20,000 to 40,000, and when a carbon content and a sulfur content of the toner measured using X-ray fluorescence are represented by [C] % and [S] %, respectively, [S]/[C] has the following relationship:
0.0002≦[S]/[C]≦0.0030 (1).

It is known that when the binder resin is obtained by polymerization of a vinyl polymerizable monomer, a sulfur-containing compound, particularly a compound having a thiol group, is added as a chain transfer agent in order to adjust the molecular weight thereof. The chain transfer agent extracts or inactivates a free radical during radical polymerization to stop the polymerization, thereby adjusting the molecular weight. The reactivity between the chain transfer agent and a free radical of an aromatic molecule is different from the reactivity between the chain transfer agent and a free radical of an aliphatic molecule. The reason is considered to be due to a high level of reactivity of an aromatic molecule having a free radical and the resistance thereof to inactivation by a compound having a thiol group.

In the case of a polymerization reaction of the toner binder resin, an aromatic molecule, such as styrene, is often used. Such an aromatic molecule tends to form a molecule having a relatively large molecular weight at an initial stage of polymerization. Therefore, as the polymerization reaction proceeds, the relative amount of the aromatic molecule is reduced while the relative amount of an aliphatic molecule is increased in the polymerizable monomers. Therefore, when the reaction proceeds to a certain extent, the degree of polymerization can be effectively adjusted with a compound having a thiol group.

The above-described characteristics are utilized in the present invention. Specifically, a polymerized product of an aromatic molecule having a relatively high level of viscosity is formed at an initial stage of polymerization, while a minimum of polymerization degree adjustment is performed at a later stage of polymerization. Thereby, uneven distribution of components is positively introduced into a polymer having the same composition, thereby achieving the present invention.

More specifically, if the amount of a compound having a thiol group is reduced, the molecular weight of the binder resin is likely to be large. To prevent this, the amount of a polymerization initiator is increased to adjust the weight average molecular weight of the binder resin to 20,000 to 40,000, thereby achieving the present invention.

The weight average molecular weight of the binder resin is 20,000 to 40,000, preferably 22,000 to 38,000, and more preferably 25,000 to 35,000.

When the weight average molecular weight is less than 20,000, the resultant binder resin does not have an effect on the offset in a halftone portion. When the weight average molecular weight exceeds 40,000, the gloss of a halftone portion is particularly lowered, so that a difference between the halftone portion and a solid portion becomes noticeable.

When a carbon content and a sulfur content of the toner measured using X-ray fluorescence are represented by [C] % and [S] %, respectively, [S]/[C] has the following relationship:
0.0002≦[S]/[C]≦0.0030 (1).

[S]/[C] is preferably 0.0005 to 0.0020, more preferably 0.0010 to 0.0015.

When [S]/[C] is less than 0.0002, a resin having a larger molecular weight tends to be formed. In this case, it is difficult to control the gloss. When [S]/[C] is more than 0.0030, the resin does not have an effect on the offset in a halftone portion.

Note that the carbon content [C] % and sulfur content [S] % of the toner are measured using an X-ray fluorescence method.

A method of using X-ray fluorescence will be described in detail. A sample (toner: 6 g) is pretreated (pressure molding) using a pressure molding machine (10 t, 1 min). Thereafter, the toner is measured using an X-ray fluorescence spectrometer (XRF-1500, manufactured by Shimadzu Corporation) under conditions: tube voltage, 40 KV; tube current, 90 mA; and measurement time, 30 min.

In the present invention, the carbon content and the sulfur content are defined with respect to the toner. Alternatively, values measured with respect to a so-called toner primary particle which does not include an external additive can be used to approximate the contents. This is because the external additive content of a toner is generally as small as 5% or less, and therefore, the difference between [S]/[C] measured with respect to the toner primary particle and [S]/[C] measured with respect to the toner is within an error range and can be regarded as being substantially equal to each other.

<Shape Factor SF1 of Toner>

The toner of the present invention preferably has a shape factor SF1 of 115 to 130 in terms of a halftone image. The transfer ability of a toner is largely relevant to the shape of the toner. It is known that as the shape of a toner becomes closer to a sphere, the transfer ability is increased.

The shape factor of the toner is calculated as follows (SF1=100 in the case of a perfect sphere).

$$SF1 = \frac{{( ML )}^{2}}{A} \times \frac{π}{4} \times 100$$

where ML represents a maximum length of a toner particle, and A represents a projected area of the toner particle.

The shape factor can be obtained using the following specific technique. An optical microscopic image of a toner sprayed onto a slide glass is captured and transferred by a video camera to an image analyzer (LUZEX). SF1 values are calculated for 50 toners based on the above-described expression. An average value of the 50 values is obtained.

In the present invention, when a halftone image is obtained, a certain high level of developing ability and transfer ability are required. If SF1 is 115 to 130, a desired unfixed image is obtained. Therefore, it preferably becomes possible to control the hot offset. Further, the toner is not transferred to a desired place, i.e., a phenomenon, such as so-called scattering or the like, does not occur, so that a desired halftone image is preferably obtained.

<Toner Particle Size Distribution GSDp>

A particle size distribution GSDp of the toner of the present invention is represented by GSDp=D50p/D16p where D16p represents a particle diameter when the number of toner particles is counted in a number particle size distribution from the smallest particle size and the count reaches 16% of the total number of toner particles, and D50p represents a particle diameter when the count reaches 50% of the total. The GSDp is preferably 1.23 or less, more preferably 1.10 or more and 1.23 or less. When the GSDp is 1.23 or less, it is preferable that there is a small amount of toner fine powder and the toner composition is uniform. It is also preferable that a particle having a significantly small release agent content is not generated, i.e., the hot offset does not occur.

The toner for the development of an electrostatic latent image comprises at least a binder resin, a colorant and a release agent. The toner can comprise an internal additive in addition to these components. The toner optionally further comprises an external additive or the like.

Hereinafter, each component contained in the toner of the present invention will be described in detail.

<Binder Resin>

A binder resin which can be used in the present invention is a radical polymerizable binder resin.

Examples of a binder resin which may be used in an electrophotographic toner of the present invention, include ethylene resins (e.g., polyethylene, polypropylene, etc.); styrene resins which contain polystyrene, poly(α-methylstyrene) or the like as a major component; (meth)acrylic resins which contain polymethylmethacrylate, polyacrylonitrile or the like as a major component; polyamide resins; polycarbonate resins; polyether resins; polyester resins; and copolymer resins thereof. In consideration of the charge stability and development duration of the electrophotographic toner, a resin which is obtained by polymerization or copolymerization of one or a plurality of different vinyl polymerizable monomers is preferable, and particularly, styrene resins, (meth)acrylic resins and styrene-(meth)acrylic copolymer resins are preferable.

Styrene resins and (meth)acrylic resins, particularly styrene-(meth)acrylic copolymer resins, are useful as the binder resin in the present invention.

A latex which is obtained by polymerization of a monomer mixture of a vinyl aromatic monomer (a styrene monomer, 60 to 90 parts by weight), an ethylene unsaturated carboxylic ester monomer (a (meth)acrylic ester monomer, 10 to 40 parts by weight) and an ethylene unsaturated acid monomer (1 to 3 parts by weight), and dispersing and stabilizing the resultant copolymer using a surfactant, can be preferably used.

The glass transition temperature of the above-described copolymer is preferably 50 to 70° C., more preferably 50 to 65° C., and even more preferably 50 to 60° C.

Hereinafter, the above-described polymerizable monomers constituting the copolymer resin will be described.

Examples of the styrene monomer include styrene, α-styrene, vinylnaphthalene, alkyl-substituted styrene having an alkyl chain (e.g., 2-methylstyrene, 3-methylstyrene, 4-methylstyrene, 2-ethylstyrene, 3-ethylstyrene, 4-ethylstyrene, etc.), halogen-substituted styrene (e.g., 2-chlorostyrene, 3-chlorostyrene, 4-chlorostyrene, etc.), fluorine-substituted styrene (e.g., 4-fluorostyrene, 2,5-difluorostyrene, etc.), and the like. Styrene is preferable as the styrene monomer.

Examples of the (meth)acrylic ester monomer include n-methyl(meth)acrylic ester, n-ethyl(meth)acrylic ester, n-propyl(meth)acrylic ester, n-butyl(meth)acrylic ester, n-pentyl(meth)acrylic ester, n-hexyl(meth)acrylic ester, n-heptyl(meth)acrylic ester, n-octyl(meth)acrylic ester, n-decyl(meth)acrylic ester, n-dodecyl(meth)acrylic ester, n-lauryl(meth)acrylic ester, n-tetradecyl(meth)acrylic ester, n-hexadecyl(meth)acrylic ester, n-octadecyl(meth)acrylic ester, isopropyl(meth)acrylic ester, isobutyl(meth)acrylic ester, t-butyl(meth)acrylic ester, isopentyl(meth)acrylic ester, amyl(meth)acrylic ester, neopentyl(meth)acrylic ester, isohexyl(meth)acrylic ester, isoheptyl(meth)acrylic ester, isooctyl(meth)acrylic ester, 2-ethylhexyl(meth)acrylic ester, phenyl(meth)acrylic ester, biphenyl(meth)acrylic ester, diphenylethyl(meth)acrylic ester, t-butylphenyl(meth)acrylic ester, terphenyl(meth)acrylic ester, cyclohexyl(meth)acrylic ester, t-butylcyclohexyl(meth)acrylic ester, dimethylaminoethyl(meth)acrylic ester, diethylaminoethyl(meth)acrylic ester, methoxyethyl(meth)acrylic ester, 2-hydroxyethyl(meth)acrylic ester, β-carboxyethyl(meth)acrylic ester, acrylonitrile(meth)acrylic ester, acrylamide(meth)acrylic ester, and the like. As the (meth)acrylic ester monomer, n-butyl(meth)acrylic ester is preferable.

The notation of (meth)acrylic ester is an abbreviation for both methacrylic ester structure and acrylic ester structure.

The ethylene unsaturated acid monomer contains an acidic group, such as a carboxyl group, a sulfonic acid group, acid anhydride or the like.

A carboxyl group can be introduced into the styrene resin, the (meth)acrylic resin and the styrene-(meth)acrylic copolymer resin by copolymerization using a polymerizable monomer having a carboxyl group.

Specific examples of the carboxyl group-containing polymerizable monomer include acrylic acid, aconitic acid, atropic acid, allylmalonic acid, angelic acid, isocrotonic acid, itaconic acid, 10-undecenoic acid, elaidic acid, erucic acid, oleic acid, ortho-carboxycinnamic acid, crotonic acid, chloroacrylic acid, chloroisocrotonic acid, chlorocrotonic acid, chlorofumaric acid, chloromaleic acid, cinnamic acid, cyclohexene dicarboxylic acid, citraconic acid, hydroxycinnamic acid, dihydroxycinnamic acid, tiglic acid, nitrocinnamic acid, vinylacetic acid, phenylcinnamic acid, 4-phenyl-3-butenoic acid, ferulic acid, fumaric acid, brassidic acid, 2-(2-furil)acrylic acid, bromocinnamic acid, bromofumaric acid, bromomaleic acid, benzylidenemalonic acid, benzoylacrylic acid, 4-pentenoic acid, maleic acid, mesaconic acid, methacrylic acid, methylcinnamic acid, methoxycinnamic acid, and the like. In consideration of ease of a polymer formation reaction, acrylic acid, methacrylic acid, maleic acid, cinnamic acid, fumaric acid and the like are preferable, more preferably acrylic acid.

A property of the binder resin of the present invention is adjusted using a chain transfer agent containing sulfur during polymerization thereof. The chain transfer agent is not particularly limited as long as it is a sulfur-containing compound. For example, a compound having a thiol component can be used. Specifically, alkyl mercaptans, such as hexyl mercaptan, heptyl mercaptan, octyl mercaptan, nonyl mercaptan, decyl mercaptan, dodecyl mercaptan and the like, are preferable. Preferably, when the alkyl mercaptans are used, the molecular weight distribution of an aliphatic polymerizable monomer can be adjusted so that the offset is satisfactorily prevented in a halftone portion. Particularly, nonyl mercaptan, decyl mercaptan and dedecyl mercaptan are preferable, and dodecyl mercaptan and dodecyl mercaptan are more preferable.

When the amount of the sulfur-containing chain transfer agent is about 0.1 to about 2.0 parts by weight in 100 parts by weight of the binder resin, 0.0002≦[S]/[C]≦0.0030 can be obtained.

A cross-linking agent can be optionally added to the binder resin in the present invention. The cross-linking agent is representatively a polyfunctional monomer containing two or more ethylene polymerizable unsaturated groups.

Specific examples of the cross-linking agent include aromatic polyvinyl compounds (e.g., divinyl benzene, dvinyl naphthalene, etc.); polyvinyl esters of aromatic polyvalent carboxylic acid (e.g., divinyl phthalate, divinyl isophthalate, divinyl terephthalate, divinyl homophthalate, divinyl/trivinyl trimesate, divinyl naphthalene dicarboxylate, divinyl biphenyl carboxylate, etc.); divinyl esters of nitrogen-containing aromatic compounds (e.g., divinyl pyridinecarboxylate, etc.); vinyl esters of unsaturated heterocyclic carboxylic acid (e.g., vinyl pyromucate, vinyl furancarboxylate, vinyl pyrrole-2-carboxylate, vinyl thiophenecarboxylate, etc.); (meth)acrylic esters of straight-chain polyvalent alcohol (e.g., butanediol methacrylate, hexanediol acrylate, octanediol methacrylate, decanediol acrylate, dodecanediol methacrylate, etc.); (meth)acrylic esters of branched, substituted polyvalent alcohol (e.g., neopentyl glycol dimethacrylate, 2-hydroxy-1,3-diacryloxypropane, etc.); polyethylene glycol di(meth)acrylate, polypropylene polyethylene glycol di(meth)acrylate; polyvinyl esters of polyvalent carboxylic acid (e.g., divinyl succinate, divinyl fumarate, vinyl/divinyl maleate, divinyl diglycolate, vinyl/divinyl itacolate, divinyl acetone dicarboxylate, divinyl glutarate, divinyl 3,3′-thiodipropionate, divinyl/trivinyl trans-aconitate, divinyl adipate, divinyl pimelate, divinyl suberate, divinyl azelate, divinyl sebacate, divinyl dodecandioate, divinyl brassylate, etc.); and the like.

In the present invention, the above-described cross-linking agents may be used singly or in combination. Among the cross-linking agents, (meth)acrylic esters of straight-chain polyvalent alcohol (e.g., butanediol methacrylate, hexanediol acrylate, octanediol methacrylate, decanediol acrylate, dodecanediol methacrylate, etc.); (meth) acrylic esters of branched, substituted polyvalent alcohol (e.g., neopentyl glycol dimethacrylate, 2-hydroxy-1,3-diacryloxypropane, etc.); polyethylene glycol di(meth)acrylate, polypropylene polyethylene glycol di(meth)acrylate; and the like, are preferable as the cross-linking agent in the present invention.

A preferable content of the cross-linking agent is in the range of 0.05 to 5% by weight of the total amount of polymerizable monomers, more preferably 0.1 to 1.0% by weight.

A binder resin for use in the toner of the present invention can be polymerized using an initiator for radical polymerization.

The radical polymerization initiator is not particularly limited. Specific examples of the radical polymerization initiator include peroxides (e.g., hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, triphenyl peracetate tert-butyl hydroperoxide, tert-butyl performate, tert-butyl peracetate, tert-butyl perbenzoate, tert-butyl phenyl peracetate, tert-butyl methoxy peracetate, ter-butyl N-(3-toluyl)percarbamate, etc.), azo compounds (e.g., 2,2′-azobispropane, 2,2′-dichloro-2,2′-azobispropane, 1,1′-azo(methylethyl)diacetate, 2,2′-azobis(2-amidinopropane)hydrochloride, 2,2′-azobis(2-aminodinopropane)nitrate, 2,2′-azobisisobutane, 2,2′-azobisisobutylamide, 2,2′-azobisisobutylonitirile,-2,2′-azobis-2-methyl methylpropionate, 2,2′-dichloro-2,2′-azobisbutane, 2,2′-azobis-2-methylbutylonitrile, 2,2′-azobisdimethyl isobutyrate, 1,1′-azobis(1-methylbutylonitrile-3-sodium sulfonate), 2-(4-methylphenylazo)-2-methyl malonodinitrile, 4,4′-azobis-4-cyanovalerate, 3,5-dihydroxymethylphenylazo-2-methyl malonodinitrile, 2-(4-bromophenylazo)-2-allyl malonodinitrile, 2,2′-azobis-2,4-methyl valeronitrile, 4,4′-azobis-4-dimethyl cyanovalerate, 2,2′-azobis-2,4-dimethylvaleronitrile, 1,1′-azobiscyclohexanenitorile, 2,2′-azobis-2-propylbutylonitorile, 1,1′-azobis-1-chlorophenylethane, 1,1′-azobis-1-cyclohexane carbonitrile, 1,1′-azobis-1-cycloheptanenitrile, 1,1′-azobis-1-phenylethane, 1,1′-azobiscumene, 4-nitrophenylazobenzylethyl cyanoacetate, phenylazodiphenylmethane, phenylazotriphenylmethane, 4-nitrophenylazotriphenylmethane, 1,1′-azobis-1,2-diphenylethane, poly(bisphenol A-4,4′-azobis-4-cyanopentanoate), poly(tetraethylene glycol-2,2′-azobisisobutyrate), etc.), 1,4-bis(pentaethylene)-2-tetrazene, 1,4-dimethoxycarbonyl-1,4-diphenyl-2-tetrazene, and the like.

<Colorant>

The toner for the development of an electrostatic latent image according to the present invention preferably contains any one or more colorants selected from cyan, magenta, yellow, black pigments and dyes. These colorants may be used singly or in combination. Two or more colorants of the same family may be mixed, or alternatively, two or more colorants of different families may be mixed.

Known colorants can be used in the present invention.

Examples of black pigment include carbon black, copper oxide, manganese dioxide, aniline black, activated carbon, non-magnetic ferrite, magnetite, and the like.

Examples of yellow pigment include lead chromate, zinc chromate, yellow iron oxide, cadmium yellow, chrome yellow, Hansa yellow, Hansa yellow 10G, benzidine yellow G, benzidine yellow GR, threne yellow, quinoline yellow, permanent yellow NCG, and the like.

Examples of orange pigment include red chrome yellow, molybdenum orange, permanent orange GTR, pyrazolone orange, vulcan orange, benzidine orange G, indathrene brilliant orange RK, and indathrene brilliant orange GK, and the like.

Examples of red pigment include iron red, cadmium red, red lead, mercury sulfate, Watchung red, permanent red 4R, lithol red, brilliant carmine 3B, brilliant carmine 6B, DuPont oil red, pyrazolone red, rhodamine B lake, lake red C, rose bengale, eoxine red, alizarin lake, and the like.

Examples of blue pigment include iron blue, cobalt blue, alkali blue lake, victoria blue lake, fast sky blue, indathrene blue BC, aniline blue, ultramarine blue, calco oil blue, methylene blue chloride, phthalocyanine blue, phthalocyanine green, malachite green oxalate, and the like.

Examples of purple pigment include manganese violet, fast violet B, methyl violet lake, and the like.

Examples of green pigment include chromium oxide, chromium green, pigment green, malachite green lake, final yellow green G, and the like.

Examples of white pigment include hydrozincite, titanium oxide, antimony white, zinc sulfate, and the like.

A dye can be optionally used. Examples of dye include various dyes, such as basic dye, acidic dye, disperse dye, direct dye and the like. Specific examples of these dyes include nigrosine, methylene blue, rose bengale, quinoline yellow, ultramarine blue, and the like. These colorants may be used singly or in admixture or in the form of solid solution.

The amount of the colorant to be added to the toner is preferably in the range of 4% by weight to 15% by weight with respect to the total weight of the solid components of the toner in order to secure the color developing ability during fixation, more preferably in the range of 4% by weight to 10% by weight. When a magnetic material is used as a black colorant, it is preferably added in the range of 12% by weight to 48% by weight, more preferably in the range of 15% by weight to 40% by weight. By appropriately selecting the above-described colorants, various color toners, such as a yellow toner, a magenta toner, a cyan toner, a black toner, a white toner, a green toner and the like, are obtained.

<Release Agent>

A release agent may be optionally added to the toner of the present invention. The release agent is generally used in order to increase the release ability of the toner. Specific examples of the release agent include low molecular weight polyolefins (e.g., polyethylene, polypropylene, polybutene, etc.); silicones having a softening point (capable of being softened by heating); fatty acid amides (e.g., oleamide, erucamide, ricinoleamide, stearamide, etc.); vegetable waxes (e.g., carnauba wax, rice wax, candelila wax, Japan wax, jojoba oil, etc.); animal waxes (e.g., beeswax, etc.); mineral/petroleum waxes (e.g., montan wax, ozokerite wax, ceresin wax, paraffin wax, microcrystalline wax, Fischer-Tropsch wax, etc.); ester waxes (e.g., fatty ester, montanate, carboxylate, etc.); and the like. In the present invention, these release agents may be used singly or in combination.

The release agent is added in an amount of 1 to 30% by weight with respect to the total amount of the toner particles, more preferably 1 to 20% by weight, and even more preferably 5 to 15% by weight.

Within the above-described range, the release agent has a sufficient effect and the toner particles resist destruction in a development machine. Therefore, preferably, the release agent is not spent to a carrier and charge is not likely to be lowered.

<Internal Additive>

A toner primary material (also referred to as a “toner primary particle”) comprises a binder resin, a colorant and a release agent. The toner primary material may be optionally provided with silica or a charge control agent as an internal additive. The toner primary material preferably has a volume average particle diameter of 2 to 10 μm, more preferably 3 to 8 μm.

Details of the internal additive will be described below.

<External Additive>

An effect of the present invention can be improved by attaching an external additive to a surface of the toner. Examples of the external additive include organic and inorganic resin microparticles.

Preferably, the external additive has a charge characteristic whose polarity is reverse to that of the toner.

—Organic Resin Microparticle Added to Toner—

An organic resin microparticle (external additive resin microparticle) to be added to the toner preferably has a weight average molecular weight Mw of 100,000 or more and 700,000 or less, more preferably 100,000 or more and 500,000 or less. The reason is inferred as follows. By securing the aggregation ability during fixation of resin molecules constituting a binder resin of the toner of the present invention, the occurrence of the hot offset in a halftone portion can be controlled. The addition of the resin microparticle improves the aggregation force.

The effect can be obtained when the weight average molecular weight Mw is within the above described range. When Mw is within the range, the resin microparticle is not deformed by stirring or the like in the development machine, thereby preferably avoiding a deterioration in fluidity of a developer. It is also preferable that the difference between Mw and the molecular weight of the binder resin of the toner is appropriate, resulting in an improvement in aggregation force.

Specific examples of the external additive resin micropartile include polyolefin resins (e.g., polyethylene, polypropylene); polyvinyl and polyvinylidene resins (e.g., polystyrene, acrylic resin, polyacrylonitorile, polyvinyl acetate, polyvinyl alcohol, polyvinyl butyral, polyvinyl chloride, polyvinyl carbazole, polyvinyl ether, and polyvinyl ketone); vinyl chloride-vinyl acetate copolymer; styrene-acrylate copolymer; straight silicon resin having an organosiloxane bond, and denatured products thereof; fluorocarbon resins (e.g., polytetrafluoroethylene, polyvinyl fluoride, polyvinylidene fluoride, polychlorotrifluoroethylene); polyester; polycarbonate; and the like. These resins can be formed simultaneously with a cross-linking component, such as divinylbenzene or the like, to obtain a curable resin particle.

Examples of a thermosetting resin include phenol resins; amino resins (e.g., urea-formaldehyde resin, melamine resin, benzoguanamine resin, urea resin, polyamide resin); epoxy resins; and the like.

For example, a polymerization method, such as suspension polymerization, emulsion polymerization or the like, may be used to form a granular resin. Alternatively, a monomer or an oligomer may be dispersed in a poor solvent so that granulation is performed due to surface tension while a cross-linking reaction is performed. Alternatively, a low molecular weight component and a cross-linking agent may be mixed and reacted by a melt-kneading method or the like, followed by pulverization into a predetermined particle size using wind power or mechanical power.

Among the above described resins, the thermoplastic resin is preferable because the above-described aggregation force is easily obtained.

The amount of an organic resin microparticle externally added is preferably about 0.1 to about 3% by weight with respect to the total weight of the toner, more preferably about 0.2 to about 2% by weight, though varying depending on the particle size of the toner.

—Resin (Inorganic) Microparticle Added to Toner—

In the present invention, a resin (inorganic) microparticle may be optionally added to the toner. The reason is inferred as follows. By improving the fluidity of the toner to cause the toner to be uniformly placed on a halftone portion, it is possible to control the hot offset.

Specific examples of the resin (inorganic) microparticle include silica, titanium oxide, zinc oxide, strontium oxide, aluminum oxide (alumina), calcium oxide, magnesium oxide, cerium oxide, a combination thereof, and the like. Examples of a metal nitride microparticle include silicon nitride, aluminum nitride, titanium nitride, zinc nitride, calcium nitride, magnesium nitride, cerium nitride, and the like. Particularly, silica, titanium oxide and aluminium oxide are preferable in terms of particle size, particle size distribution and productivity.

The amount of the added resin (inorganic) microparticle is preferably about 0.1 to about 5% by weight, more preferably about 0.5 to about 3% by weight, with respect to the total amount of the toner.

In the present invention, the external additive is added and mixed with the toner particle using a known mixer, such as a V-type mixer, a Henschel mixer, a Lodige mixer, or the like.

(Method of Producing Toner for Development of Electrostatic Latent Image)

A method of producing a toner for the development of an electrostatic latent image comprises mixing at least a resin particle dispersion solution in which a resin particle having a particle diameter of 1 μm or less is dispersed, with a colorant dispersion solution in which a colorant is dispersed, to aggregate the binder resin particle and the colorant into a particle having a toner particle diameter (aggregation step); and heating the resultant aggregate particle to no less than the glass transition temperature of the binder resin particle to fuse the aggregate material to form a toner particle. In this case, the binder resin has a weight average molecular weight of 20,000 to 40,000. When a carbon content and a sulfur content of the toner which is obtained by causing a sulfur compound to coexist when preparing the resin particle dispersion solution are represented by [C] % and [S] %, respectively, as measured using X-ray fluorescence, [S]/[C] has the following relationship:
0.0002≦[S]/[C]≦0.0030 (2).

In the aggregation step, a release agent dispersion solution and various additives may be optionally mixed in addition to the resin particle dispersion solution and the colorant dispersion solution. Examples of the additive include a surfactant, a charge control agent, an aggregating agent, and the like.

The method of producing a toner for the development electrostatic latent image according to the present invention is preferably achieved using an emulsion polymerization and aggregation method in which a binder resin polymerizable monomer is emulsion-polymerized, and a dispersion solution of the binder resin is mixed with a dispersion solution containing a colorant, a release agent and, optionally, a charge control agent or the like, followed by aggregation and thermal fusion, to obtain a toner particle.

The toner of the present invention is not limited by the above-described production method. In the present invention, various known techniques can be employed: a kneading-pulverization method in which a binder resin, a colorant, a release agent and, optionally, a charge control agent or the like, are subjected to kneading, pulverization and classification; a method of changing the shape of a particle obtained by the kneading-pulverization method, using mechanical impact force or thermal energy; a suspension polymerization method in which a solution of a polymerizable monomer for obtaining a binder resin, a colorant, a release agent and, optionally, a charge control agent or the like is suspended in a water-based solvent, followed by polymerization; a dissolution suspension method in which a solution of a binder resin, a colorant, a release agent and, optionally, a charge control agent or the like is suspended in a water-based solvent to form a particle; and the like. In addition, the toner obtained using the above-described method can be used as a core, and an aggregate particle is attached thereto, followed by thermal fusion, to obtain a core-shell structure. To obtain an appropriate sulfur content and weight average molecular weight, the above-described emulsion polymerization and aggregation method can be preferably used.

Hereinafter, the emulsion polymerization and aggregation method will be described in detail.

The emulsion polymerization and aggregation method comprises mixing at least a resin particle dispersion solution in which a resin particle having a particle diameter of 1 μm or less is dispersed and, for example, a colorant dispersion solution in which a colorant is dispersed, to aggregate the binder resin particle and the colorant into a particle having a toner particle diameter (aggregation step), and heating the resultant aggregate particle to a temperature which is higher than or equal to the glass transition temperature of the binder resin particle so that the aggregate particle is fused to form a toner particle (fusion step).

The resin particle has a particle diameter of 1 μm or less, preferably 50 nm or more and 1 μm or less, more preferably 75 to 750nm, and even more preferably 100 to 500 nm.

In the aggregation step, particles in the resin particle dispersion solution, the colorant dispersion solution and, optionally, a release agent dispersion solution, which are mixed together, are aggregated to form an aggregate particle. The aggregation particle is formed by heteroaggregation or the like. To stabilize the aggregation particle and control the particle size/particle size distribution thereof, an ionic surfactant having a polarity reverse to that of the aggregation particle or a compound having at least monovalent charge, such as a metal salt or the like, is added to the aggregation particle.

In the fusion step, the resin particle in the aggregation particle is melted at a temperature which is higher than or equal to the glass transition temperature thereof, so that the shape of the aggregation particle is changed from amorphous to spherical. In this case, the shape factor SF1 of the aggregation particle is generally 150 or more. However, as the shape of the aggregation particle is changed to be closer to a sphere, the SF1 is reduced. When a desired shape factor is reached, the heating of the toner is stopped. In this manner, the shape factor SF1 can be controlled. Thereafter, the aggregate product is isolated from the water-based solvent, optionally followed by washing and drying, to form a toner primary particle.

A polymer of the above-described polymerizable monomer can be used as the resin molecule. When a polymerizable monomer into which a functional group having a relatively large number of carbon atoms is introduced is optionally used, a uniform gloss can be preferably obtained. As the functional group, an aliphatic one having 6 or more carbon atoms is preferably used. Specifically, an alkyl group (e.g., hexyl, cyclohexyl, heptyl, octyl, nonyl, butyl, lauryl, cetyl, stearyl, oleyl, behenyl, etc.), an alkylene group, an alicyclic hydrocarbon group (e.g., a cholesteryl group, etc.), or the like is preferably used.

More specifically, examples of the above-described polymerizable monomer include hexyl acrylate, hexyl methacrylate, 2-ethylhexyl acrylate, 2-ethylhexyl methacrylate, butyl acrylate, butyl methacrylate, stearyl acryalte, stearyl methacrylate, behenyl acrylate, behenyl methacrylate, and the like.

These may be used singly or in combination.

A preferable content of the polymerizable monomer is preferably in the range of 0.1 to 5% by weight with respect to the total amount of polymerizable monomers, more preferably 0.3 to 3% by weight, and even more preferably 0.5 to 2% by weight, though it varies depending on the length of the functional group.

Within the range, an effect of the addition is obtained, and further, the glass transition temperature is not lowered, so that the shelf life of the toner is preferably not reduced.

<Dispersion Method of Colorant>

A colorant for use in the toner of the present invention can be dispersed in the binder resin using a known method. When the toner is produced using a kneading-pulverization method, the colorant may be used as it is. Alternatively, the colorant may be dispersed in the resin to a high concentration before kneading together with the binder resin (master batch). Alternatively, after synthesis of the colorant, the colorant in a wet cake state may be dispersed in the resin (flashing).

The colorant can be used as it is for toner production using the suspension polymerization method. In the suspension polymerization method, by allowing the colorant dispersed in the resin to be dissolved or dispersed into the polymerizable monomer, the colorant can be dispersed in the resultant particle.

When the toner is produced using the emulsion polymerization and aggregation method, the colorant is dispersed along with a dispersion agent, such as a surfactant or the like, into a water-based solvent by mechanical impact or the like to prepare a colorant dispersion solution, and the colorant and the binder resin particle are aggregated to form a toner particle having a toner diameter.

Specifically, the colorant dispersion by mechanical impact or the like can be achieved as follows. For example, a media dispersing machine (e.g., a rotor-stator homogenizer, a ball mill, a sand mill, an attritor, etc.), a high pressure collision dispersing machine or the like can be used to prepare a colorant particle dispersion solution. The colorant can also be dispersed into a water-based solvent using a surfactant having polarity and using a homogenizer.

<Surfactant>

In the production method of the toner of the present invention, a surfactant can be used for the purpose of, for example, stabilization during dispersion in the suspension polymerization method, or stabilization of dispersion of the resin particle dispersion solution, the colorant dispersion solution and the release agent dispersion solution in the emulsion polymerization and aggregation method.

Examples of the surfactant include anionic surfactants (e.g., sulfate surfactants, sulfonate surfactants, phosphate surfactants, soap surfactants, etc.); cationic surfactants (e.g., amine salt type surfactants, quaternary ammonium salt type surfactants, etc.); nonionic surfactants (e.g., polyethyleneglycol surfactants, alkylphenolethylene oxide adduct surfactants, polyvalent alcohol surfactants, etc.); and the like. Particularly, the ionic surfactants are preferable, and the anion surfactants and the cationic surfactants are more preferable.

In the toner of the present invention, the anionic surfactant generally has a strong dispersing ability, thereby excellently dispersing a resin particle and a colorant. The anionic surfactant is also advantageous as a surfactant for dispersing a release agent.

The nonionic surfactant is preferably used in combination with the anionic surfactant or the cationic surfactant. The above-described surfactants may be used singly or in combination.

Specific examples of the anionic surfactant include fatty acid soaps (e.g., potassium laurylate, sodium oleate, sodium castor oil, etc.); sulfates (e.g., octyl sulfate, lauryl sulfate, lauryl ether sulfate, nonylphenyl ether sulfate, etc.); sodium alkylnaphthalene sulfates (e.g., lauryl sulfonate, dodecylbenzene sulfonate, triisopropylnaphthalene sulfonate, dibutylnaphthalene sulfonate, etc.); sulfonates (e.g., naphthalenesulfonate formalin condensation product, monooctyl sulfosuccinate, dioctyl sulfosuccinate, lauryl amide sulfonate, oleyl amide sulfonate, etc.); phosphates (e.g., lauryl phosphate, isopropyl phosphate, nonylphenyl ether phosphate, etc.); dialkylsulfosuccinates (e.g., sodium dioctylsulfosuccinate, etc.); sulfosuccinates (e.g., disodium lauryl sulfosuccinate, etc.); and the like.

Specific examples of the cationic surfactant include amine salts (e.g., lauryl amine hydrochloride, stearyl amine hydrochloride, oleyl amine acetate, stearyl amine acetate, stearyl aminopropyl amine acetate, etc.); quaternary ammonium salts (e.g., lauryl trimethyl ammonium chloride, dilauryl dimethyl ammonium chloride, distearyl dimethyl ammonium chloride, lauryl dihydroxy ethylmethyl ammonium chloride, oleylbis polyoxyethylene methyl ammonium chloride, lauroyl aminopropyl dimethylethyl ammonium ethosulfate, lauroyl aminopropyl dimethylhydroxyethyl ammonium perchlorate, alkylbenzene trimethyl ammonium chloride, alkyl trimethyl ammonium chloride, etc.); and the like.

Specific examples of the nonionic surfactant include alkyl ethers (e.g., polyoxyethylene octyl ether, polyoxyethylene lauryl ether, polyoxyethylene stearyl ether, polyoxyethylene oleyl ether, etc.); alkylphenyl ethers (e.g., polyoxyethylene octylphenyl ether, polyoxyethylene nonylphenyl ether, etc.) ; alkyl esters (e.g., polyoxyethylene laurate, polyoxyethylene stearate, polyoxyethylene oleate, etc.); alkyl amines (e.g., polyoxyethylene laurylamino ether, polyoxyethylene oleylamino eter, polyoxyethylene soybean amino ether, polyoxyethylene tallow amino ether, etc.); alkyl amides (e.g., polyoxyethylene lauryl amide, polyoxyethylene stearyl amide, polyoxyethylene oleyl amide, etc.); vegetable oil ethers (e.g., polyoxyethylene castor oil ether, polyoxyethylene rape oil ether, etc.); alkanolamides (e.g., lauryl diethenol amide, stearyl diethanol amide, oleyl diethanol amide, etc.); sorbitan ester ethers (e.g., polyoxyethylene sorbitan monolaurate, polyoxyethylene sorbitan monopalmiate, polyoxyethylene sorbitan monostearate, polyoxyethylene sorbitan monooleate, etc.); and the like.

The surfactant content of each dispersion solution may be any value which does not inhibit the present invention, and is generally small, specifically in the range of 0.01 to 3% by weight, more preferably 0.05 to 2% by weight, and even more preferably 0.1 to 2% by weight. When the content is within the range, the resin particle dispersion solution, the colorant dispersion solution, the release agent dispersion solution and the like are each stable, so that aggregation or liberation of a specific particle does not occur, and the weight average molecular weight is not affected during polymerization of the binder resin. Therefore, the effect of the present invention is sufficiently obtained. In general, a dispersion of a suspension-polymerized toner having a large particle diameter is stable even when the amount of a surfactant used therein is small.

<Dispersion Stabilizer>

As a dispersion stabilizer for use in the suspension polymerization method or the like, slightly water-soluble and hydrophilic inorganic fine-powder can be used. Examples of the inorganic fine-powder employable therein include silica, aluminium oxide, titanium oxide, calcium carbonate, magnesium carbonate, tricalcium phosphate (hydroxyapatite), clay, diatomaceous earth, bentonite, and the like. Particularly, calcium carbonate, tricalcium phosphate and the like are preferable in terms of ease of control of the particle size of a microparticle and ease of removal.

For example, a hydrophilic polymer which is solid at room temperature can also be used as the dispersion stabilizer. Specifically, cellulose compounds (e.g., carboxymethyl cellulose, hyroxypropyl cellulose, etc.), polyvinyl alcohol, gelatin, starch, gum arabic and the like can be used.

<Charge Control Agent>

A charge control agent may be optionally added to the toner of the present invention.

Known charge control agents can be used, including azo metal complex compounds, metal complex compounds of salicylic acid, and resins having a polar group. When the toner is produced using a wet production method, a less water-soluble material is preferably used in terms of control of ionic strength and reduction of wastewater pollution. Note that the toner of the present invention may be either a magnetic toner enclosing a magnetic material or a non-magnetic toner without a magnetic material.

<Aggregating Agent>

When the emulsion polymerization and aggregation method is applied to the production of the toner of the present invention, aggregation is generated by, for example, changing pH in the aggregation step, thereby preparing a particle which contains a binder resin and a colorant and has a toner particle diameter. An aggregating agent may be simultaneously added in order to stabilize or accelerate the aggregation of particles or obtain an aggregation particle having a narrower particle size distribution.

As the aggregating agent, a compound having at least monovalent charge is preferable. Specific examples of such an aggregating agent include the above-described ionic surfactants; water-soluble surfactants (e.g., nonionic surfactants, etc.); acids (e.g., hydrochloric acid, sulfuric acid, nitric acid, acetic acid, oxalic acid, etc.); metal salts of inorganic acids (e.g., magnesium chloride, sodium chloride, aluminum chloride, aluminum sulfate, calcium sulfate, ammonium sulfate, aluminum nitrate, silver nitrate, copper sulfate, sodium carbonate, etc.); metal salts of aliphatic or aromatic acids (e.g., sodium acetate, potassium formate, sodium oxalate, sodium phthalate, potassium salicylate, etc.); metal salts of phenols (e.g., sodium phenolate, etc.); metal salts of amino acids; inorganic acid salts of aliphatic or aromatic amines (e.g, triethanol amine hydrochloride, aniline hydrochloride, etc.); and the like.

In consideration of the stability of the aggregation particle, the thermal or temporal stability of the aggregating agent, and the removal of the aggregating agent during washing, metal salts of inorganic acids are preferable as the aggregating agents in terms of performance and use. Specific examples of the inorganic acid metal salts include magnesium chloride, sodium chloride, aluminum chloride, aluminum sulfate, calcium sulfate, ammonium sulfate, aluminum nitrate, silver nitrate, copper sulfate, sodium carbonate, and the like.

These aggregating agents are preferably added in a small amount with respect to the total amount of the toner, though it varies depending on the valence, i.e., about 3% by weight or less when the valence is one, about 1% by weight or less when the valence is two, and about 0.5% by weight when the valence is three. Since it is preferable that the amount of the aggregation agent is small, a compound having a high valence is preferably used.

(Electrostatic Latent Image Developer)

The electrostatic latent image developer of the present invention comprises the above-described toner for the development of an electrostatic image of the present invention.

Specifically, the electrostatic latent image developer of the present invention (hereinafter also simply referred to as a “developer”) is produced by mixing the above-described toner and a carrier described below. A mixture ratio (weight ratio) of the toner and the carrier in the developer is preferably in the range of 1:99 to 20:80 (toner:carrier), more preferably 3:97 to 12:88.

<Carrier>

A carrier which may be used in the developer of the present invention is not particularly limited. Known carriers can be used. An example of the carrier is a resin-coated carrier having a resin coating layer on a surface of a core material. Alternatively, a resin-dispersed carrier in which magnetic powder or the like is dispersed in a matrix resin may be used.

Examples of the coating resin/matrix resin for use in the carrier include, but are not limited to, polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymer, styrene-acrylate copolymer, straight silicone resin having an organosiloxane bond and a denatured product thereof, fluorocarbon resin, polyester, polycarbonate, phenol resin, epoxy resin, urea resin, urethane resin, melamine resin, and the like.

In general, the carrier preferably has an appropriate electric resistance value. In order to adjust the resistance, an electrically conductive fine powder is preferably dispersed in the resin. Examples of the conductive fine powder include, but are not limited to, metals (e.g., gold, silver, copper, etc.), carbon black, titanium oxide, zinc oxide; barium sulfate, aluminum borate, potassium titanate, tin oxide, and the like.

Examples of the core material of the carrier include, but are not limited to, magnetic metals (e.g., iron, nickel, cobalt, etc.); magnetic oxides (e.g., ferrite, magnetite, etc.); glass beads; and the like. A magnetic material is preferable when the carrier is used in a magnetic brush method. The carrier core material preferably has a volume average particle diameter in the range of 10 to 100 μm, more preferably 25 to 50 μm.

To coat a surface of the carrier core material with a resin, a solution for forming a coating layer is used, which is obtained by dissolving the coating resin and, optionally, various additives in an appropriate solvent. The solvent is not particularly limited and may be selected as appropriate, taking into account the coating resin, the application suitability and the like.

Specific examples of the resin coating method include an immersion method of immersing a powder of the carrier core material in the coating layer formation solution; a spray method of spraying the coating layer formation solution onto the surface of the carrier core material; a fluid bed method of spraying the coating layer formation solution onto the carrier core material which is floated in flowing air, and a kneader coater method of mixing the carrier core material and the coating layer formation solution in a kneader coater and removing the solvent.

(Image Forming Method)

Hereinafter, the image forming method of the present invention will be described in detail.

The image forming method of the present invention comprises forming an electrostatic latent image on a surface of a latent image carrier, developing the latent image using a developer to form a developed image, transferring the developed image onto a fixing base material, and fixing the developed image on the fixing base material by heating using a fixing member. In the method, the toner for development of an electrostatic latent image of the present invention, or an electrostatic image developer including it is used as a developer.

The latent image forming step comprises charging a photoreceptor and exposing the photoreceptor to form a latent image. Specifically, a surface of the photoreceptor (the electrostatic latent image carrier) is uniformly charged using a charging means. Thereafter, the latent image carrier is exposed using a laser optical system, an LED array or the like to form an electrostatic latent image. Examples of the charging means include a non-contact charger (e.g., a corotron, a scorotron, etc.), and a contact charger for charging the surface of the latent image carrier by applying a voltage to an electrically conductive member which is contacted with the surface of the latent image carrier, and the like. Any type of charger may be used. Particularly, the contact charge is preferable because of a small amount of ozone generated and an excellent ability to withstand printing. In the contact charger, the electrically conductive member may have a shape of a brush, a blade, a pin electrode, a roller or the like. Particularly, a roller-like member is preferable. There is no particular limitation on the latent image forming step in the image forming method of the present invention.

The developing step is the step of causing a developer carrier on whose surface a developer layer containing at least a toner is formed, to contact or approach the surface of the latent image carrier, thereby attaching a toner particle to an electrostatic latent image on the surface of the latent image carrier, thereby forming a toner image (developed image) on the surface of the latent image carrier. A known developing method can be used. A developing method using a dual-component developer includes a cascade developing method, a magnetic brush developing method, and the like. There is no particular limitation on the developing method in the image forming method of the present invention.

The transferring step is the step of transferring a toner image formed on the surface of the latent image carrier onto the fixing base material to form a transferred image. Examples of a transfer apparatus for transferring the toner image from the latent image carrier onto paper or the like include the related-art corotron and scorotron. Alternatively, a method of using an electrically conductive bias transfer roll comprising an elastic material, which generates only a small amount of ozone, may be used. A commonly used transfer roll is obtained by coating a surface of a metal roll with a rubber layer and treating the surface rubber layer with fluorine. Further, a cleaning apparatus whose cleaning blade is placed to contact the transfer roll is provided in order to effectively avoid adhesion of a residual toner to the transfer roll. The cleaning blade may be made of an elastic material, such as urethane rubber or the like, in order not to scratch a fluorine-treated film which is a surface coating layer of the transfer roll. The transfer roll member and the roll cleaning means are not particularly limited. Note that the bias transfer roll is caused to contact and press the latent image carrier with a line pressure of 5 g/cm or more to transfer a toner image onto paper (contact transfer).

The fixing step is the step of fixing the toner image transferred to a surface of a recording medium using a fixing apparatus. As the fixing apparatus, a heating and fixing apparatus using a heating roll is preferably used. For example, the heating and fixing apparatus may comprise a fixing roller provided with a heating heater lamp in a cylindrical core metal and having a so-called releasing layer made of a heat resistant resin coating layer or a heat resistant coating layer on its outer circumferential surface, and a press roller or press belt which is disposed to contact and press the fixing roller and which has a heat resistant elastic material layer formed on an outer circumferential surface of a cylindrical core metal or on a surface of a belt-like base material. In a process of fixing an unfixed toner image, a recording material on which an unfixed toner image is formed is passed between the fixing roller and the press roller or press belt, whereby fixation is performed by thermally fusing a binding resin, an additive and the like in a toner. In the image forming method of the present invention, the fixing method is not particularly limited.

In the image forming method of the present invention, when a full-color image is formed, a plurality of latent image carriers are provided which have respective color developer carriers. The latent image carriers and the developer carriers each perform a series of steps including the latent image forming step, the developing step and the transferring step, thereby successively forming and superposing respective color toner images on the surface of the same recording material in each step. The layered full-color toner images are thermally fixed in the fixing step. By using the electrostatic latent image developer in the image forming method, stable performance of development, transfer and fixation can be obtained even in a tandem scheme which is suitable for miniaturization and high-speed color printing.

Examples of the recording material on which a toner image is to be transferred include ordinary paper, OHP sheet and the like for use in electrophotographic copiers, printers and the like. In order to improve the smoothness of image surface after fixation, it is preferable that the recording medium has as smooth a surface as possible. For example, coat paper which is obtained by coating a surface of paper with a resin or the like, art paper for printing, and the like can be preferably used.

According to the image forming method of the present invention, it is possible to obtain an image with a high transfer rate and high quality for a long time without impairment of image quality (e.g., image irregularities, etc.).

<Contact Time of Fixing Member>

The contact time of a fixing member in the image forming method of the present invention is generally represented with a nip time, i.e., a time for which a recording medium (e.g., paper, etc.) contacts the fixing member. More specifically, the nip time is obtained by dividing a contact width between the fixing member and the recording material by the speed of the recording material passing through the contact width:
the contact time of the fixing member=(the contact width of the fixing member)/(the speed of the recording material passing therethrough).

For example, when the contact width of the fixing member is 5 mm and the speed of the recording material passing therethrough is 100 mm/s, the contact time of the fixing member is 5/100=0.05 sec.

In the present invention, the contact time of the fixing member is preferably 0.02 to 0.1 sec, more preferably 0.03 to 0.08 sec. When the contact time is within the range, the aggregation ability of the toner can be preferably maintained during high-temperature fixation to suppress the occurrence of the hot offset. Further, fixation behavior is preferably suppressed from varying depending on the amount of the toner placed on the recording material. More specifically, it is preferably possible to avoid a temperature region in which fixation is achieved in a halftone portion but not in a solid portion.

### EXAMPLES

Hereinafter, the present invention will be described by way of examples. The present invention is not limited to the examples.

Note that, in the following description, “part” means part by weight unless otherwise specified.

(Methods for Measuring Various Characteristics)

Firstly, methods for measuring and evaluating a toner and a developer used in examples and comparative examples below will be described.

<Method for Measuring Particle Size and Particle Size Distribution>

Measurement of a particle size and a particle size distribution used herein will be described. When a particle to be measured herein had a size of 2 μm or more, Coulter counter TA-II (manufactured by Beckman Coulter, Inc.) is used as a measuring apparatus and ISOTON-II (manufactured by Beckman Coulter, Inc.) is used as electrolytic solution.

In the measuring method, 0.5 to 50 mg of a sample to be measured is added to 2 ml of aqueous solution of 5% surfactant as a dispersing agent (preferably, sodium alkylbenzene sulfonate). The resultant mixture is added to 100 to 150 ml of the electrolytic solution.

The electrolytic solution in which the sample is suspended is subjected to dispersion treatment for about one minute using an ultrasonic disperser. The Coulter counter TA-II is used to measure a particle size distribution of particles having a size of 2 to 60 μm, where an aperture having an aperture diameter of 100 μm is used. Thereafter, the volume average distribution and the number average distribution are obtained. The number of the measured particles is 50,000.

A particle size distribution of the toner of the present invention is obtained using a method described as follows. The measured particle size distribution is divided into particle ranges (channels). A volume accumulation distribution is drawn from the smallest particle size. A volume average diameter when the accumulation reaches 50% is defined as D50v (or simply D50). A number particle diameter when the accumulation reaches 16% is defined as D16p. A number particle diameter when the accumulation reaches 50% is defined as D50p.

GSDp of the present invention is calculated by:
GSDp=(D50p)/(D16p).
<Method for Measuring Shape Factor SF1 of Toner>

The toner shape factor SF1 is obtained as follows. A toner is sprayed onto a slide glass. An optical microscopic image of the toner is captured and transferred by a video camera to an image analyzer (LUZEX). The SF1 is calculated for 50 toners having a maximum length (ML) and a projected area (A) by:

$$SF1 = \frac{{( ML )}^{2}}{A} \times \frac{π}{4} \times 100.$$

<Measuring Method Using X-Ray Fluorescence>

A sample (toner: 6 g) is pretreated (pressure molding) using a pressure molding machine (10 t, 1 min).

Thereafter, the toner is measured using an X-ray fluorescence spectrometer (XRF-1500, manufactured by Shimadzu Corporation) under conditions: tube voltage, 40 KV; tube current, 90 mA; and measurement time, 30 min.

<Methods for Measuring Molecular Weight and Molecular Weight Distribution of Toner and Resin Particle>

A molecular weight distribution of the toner for the development of an electrostatic latent image of the present invention is specified under the following conditions. GPC is “HLC-8120GPC, SC-8020 (manufactured by Tosoh Corporation)”. Two columns are used, which are “TSK-gel, Super HM-H (manufactured by Tosoh Corporation, 6.0 mmID×15 cm)”. Tetrahydrofran (THF) is used as eluant. Experimental conditions are: sample concentration, 0.5%; flow rate, 0.6 ml/min; sample amount, 10 μl; and measurement temperature, 40° C. The experiment is performed using an IR detector. A calibration curve is created using 10 samples manufactured by Tosoh Corporation (“polystyrene standard sample TSK standard”: “A-500”, “F-1”, “F-10”, “F-80”, “F-380”, “A-2500”, “F-4”, “F-40”, “F-128”, and “F-700”)

<Method for Measuring Melting Point of Release Agent and Glass Transition Temperature of Toner>

The melting point of a release agent used in the toner of the present invention and the glass transition temperature of the toner are obtained from a global maximum peak measured in accordance with ASTMD3418-8.

The global maximum peak can be measured using DSC-7 (manufactured by PerkinElmer, Inc). A detector section of the apparatus adjusts temperature using the melting points of indium and zinc, and adjusts heat quantity using the heat of fusion of indium. A sample is measured on a pan made of aluminum with a temperature increase rate of 10° C./min. As a control, an empty pan is used.

(Production of toner)
<Preparation of each dispersion solution>
Preparation of resin particle dispersion solution (1)

| | | |
|---|---|---|
| styrene | 160 | parts |
| n-butyl acrylate | 40 | parts |
| stearyl acrylate | 1.0 | parts |
| acrylic acid | 4.0 | parts |
| octanediol diacrylate | 1.0 | parts |
| t-dodecyl mercaptan | 1.2 | parts |

The above-described components (all manufactured by Wako Pure Chemical Industries, Ltd.) are mixed together and dissolved. The resultant mixture is dispersed and emulsified in a flask containing a solution of 4 parts of an anion surfactant (Neogen RK, manufactured by Dai-ichi Kogyo Seiyaku Co., Ltd.) in 261 parts of ion-exchanged water. The resultant mixture is slowly mixed for 10 minutes. 50 parts of hydrogen peroxide aqueous solution in which 24 parts of 30% hydrogen peroxide water (manufactured by Wako Pure Chemical Industries, Ltd.) is dissolved is poured into the mixture, followed by nitrogen replacement. Thereafter, the contents of the flask are heated in an oil bath to 75° C. while stirring. Emulsion polymerization is allowed to proceed for 7 hours. Thereafter, the reaction solution is cooled to room temperature. Thus, a resin particle dispersion solution (1) is prepared.

Next, a portion of the resin particle dispersion solution (1) is allowed to stand in an oven at 80° C. to remove the water content. Characteristics of the resultant residue are measured. As a result, the volume average particle diameter is 210 nm, the glass transition temperature is 53° C., and the weight average molecular weight Mw is 31,000. The resin particle dispersion solution (1) had a solid content of 40.0%.

—Preparation of Resin Particle Dispersion Solution (2)—

A resin particle dispersion solution (2) is prepared in the same manner as that of the resin particle dispersion solution (1), except that 0.22 parts of t-dodecyl mercaptan is used instead of 1.2 parts, and 50 parts of hydrogen peroxide aqueous solution in which 40 parts of 30% hydrogen peroxide water is dissolved is used. A portion of the resin particle dispersion solution (2) is allowed to stand in an oven at 80° C. to remove the water content. Characteristics of the resultant residue are measured. As a result, the volume average particle diameter is 200 nm, the glass transition temperature is 52° C., and the weight average molecular weight Mw is 33,000. The solid content is 40.0%.

—Preparation of Resin Particle Dispersion Solution (3)—

A resin particle dispersion solution (3) is prepared in the same manner as that of the resin particle dispersion solution (1), except that 3.6 parts of t-dodecyl mercaptan is used instead of 1.2 parts, and 50 parts of hydrogen peroxide aqueous solution in which 9.3 parts of 30% hydrogen peroxide water is dissolved is used. A portion of the resin particle dispersion solution (3) is allowed to stand in an oven at 80° C. to remove the water content. Characteristics of the resultant residue are measured. As a result, the volume average particle diameter is 210 nm, the glass transition temperature is 51° C., and the weight average molecular weight Mw is 28,000. The solid content is 40.0%.

—Preparation of Resin Particle Dispersion Solution (4)—

A resin particle dispersion solution (4) is prepared in the same manner as that of the resin particle dispersion solution (1), except that 50 parts of hydrogen peroxide aqueous solution in which 28 parts of 30% hydrogen peroxide water is dissolved is used. A portion of the resin particle dispersion solution (4) is allowed to stand in an oven at 80° C. to remove the water content. Characteristics of the resultant residue are measured. As a result, the volume average particle diameter is 200 nm, the glass transition temperature is 51° C., and the weight average molecular weight Mw is 22,000. The solid content is 40.0%.

—Preparation of Resin Particle Dispersion Solution (5)—

A resin particle dispersion solution (5) is prepared in the same manner as that of the resin particle dispersion solution (1), except that 50 parts of hydrogen peroxide aqueous solution in which 17.3 parts of 30% hydrogen peroxide water is dissolved is used. A portion of the resin particle dispersion solution (5) is allowed to stand in an oven at 80° C. to remove the water content. Characteristics of the resultant residue are measured. As a result, the volume average particle diameter is 220 nm, the glass transition temperature is 54° C., and the weight average molecular weight Mw is 39,000. The solid content is 40.0%.

—Preparation of Resin Particle Dispersion Solution (6)—

A resin particle dispersion solution (6) is prepared in the same manner as that of the resin particle dispersion solution (1), except that 0.12 parts of t-dodecyl mercaptan is used instead of 1.2 parts, and 66.7 parts of 30% hydrogen peroxide water is used. A portion of the resin particle dispersion solution (6) is allowed to stand in an oven at 80° C. to remove the water content. Characteristics of the resultant residue are measured. As a result, the volume average particle diameter is 210 nm, the glass transition temperature is 54° C., and the weight average molecular weight Mw is 30,000. The solid content is 40.0%.

—Preparation of Resin Particle Dispersion Solution (7)—

A resin particle dispersion solution (7) is prepared in the same manner as that of the resin particle dispersion solution (1), except that 4.0 parts of t-dodecyl mercaptan is used instead of 1.2 parts, and 50 parts of hydrogen peroxide aqueous solution in which 8 parts of 30% hydrogen peroxide water is dissolved is used. A portion of the resin particle dispersion solution (7) is allowed to stand in an oven at 80° C. to remove the water content. Characteristics of the resultant residue are measured. As a result, the volume average particle diameter is 220 nm, the glass transition temperature is 53° C., and the weight average molecular weight Mw is 28,000. The solid content is 40.0%.

—Preparation of Resin Particle Dispersion Solution (8)—

A resin particle dispersion solution (8) is prepared in the same manner as that of the resin particle dispersion solution (1), except that 50 parts of hydrogen peroxide aqueous solution in which 33.3 parts of 30% hydrogen peroxide water is dissolved is used. A portion of the resin particle dispersion solution (8) is allowed to stand in an oven at 80° C. to remove the water content. Characteristics of the resultant residue are measured. As a result, the volume average particle diameter is 190 nm, the glass transition temperature is 52° C., and the weight average molecular weight Mw is 18,000. The solid content is 40.0%.

—Preparation of Resin Particle Dispersion Solution (9)—

A resin particle dispersion solution (9) is prepared in the same manner as that of the resin particle dispersion solution (1), except that 50 parts of hydrogen peroxide aqueous solution in which 1.4 parts of 30% hydrogen peroxide water is dissolved is used. A portion of the resin particle dispersion solution (9) is allowed to stand in an oven at 80° C. to remove the water content. Characteristics of the resultant residue are measured. As a result, the volume average particle diameter is 200 nm, the glass transition temperature is 53° C., and the weight average molecular weight Mw is 43,000. The solid content is 40.0%.

—Preparation of Resin Particle (1)—

900 parts of ion-exchanged water is added to 100 parts of the resin particle dispersion solution (9), followed by centrifugation to separate the resin particle from the water-based solvent. The water-based solvent is discarded. Ion-exchanged water is added to the resin particle, followed by stirring. The solution is centrifuged, and the water-based solvent is discarded. The operation is repeatedly performed 10 times. Thereafter, the wet resin particle is lyophilized. The resultant resin particle is pulverized using a jet mill. The pulverized particles are collected using a bug filter. Thus, a resin particle (1) is obtained. The volume average particle diameter is 200 nm, the glass transition temperature is 53° C., and the weight average molecular weight Mw is 43,000.

Preparation of colorant dispersion solution (1)

| | |
|---|---|
| phthalocyanine pigment (cyanine blue 4937, manufactured | 100 parts |
| by Dainichiseika Color & Chemicals Mfg. Co., Ltd.) | |
| anion surfactant (Neogen RK, manufactured by Dai-ichi | 10 parts |
| Kogyo Seiyaku Co., Ltd.) | |
| ion-exchanged water | 490 parts |

The above-described materials are mixed together and dissolved, followed by dispersion using a homogenizer (Ultra Turrax T50, manufactured by IKA) to prepare a colorant dispersion solution (1).

—Preparation of Colorant Dispersion Solution (2)—

A colorant dispersion solution (2) is prepared in the same manner as that of the colorant dispersion solution (1), except that the colorant is changed to C. I. pigment red 122 (Chromofine magenta 6887, quinacridon pigment, Dainichiseika Color & Chemicals Mfg. Co., Ltd.)

—Preparation of Colorant Dispersion Solution (3)—

A colorant dispersion solution (3) is prepared in the same manner as that of the colorant dispersion solution (1), except that the colorant is changed to C. I. pigment yellow 74 (Seikafast yellow 2054, monoazo pigment, Dainichiseika Color & Chemicals Mfg. Co., Ltd.).

—Preparation of Colorant Dispersion Solution (4)—

A colorant dispersion solution (4) is prepared in the same manner as that of the colorant dispersion solution (1), except that the colorant is changed to carbon black (Regal 330, manufactured by Cabot Corporation).

Preparation of release agent dispersion solution

| | |
|---|---|
| polyethylene wax (Polywax 725, manufactured by Toyo- | 100 parts |
| Petrolite) | |
| anion surfactant (Neogen RK, manufactured by Dai-ichi | 10 parts |
| Kogyo Seiyaku Co., Ltd.) | |
| ion-exchanged water | 390 parts |

The above-described materials are mixed, followed by dispersion treatment for one hour using a pressure discharge homogenizer at 115° C. and 350 kg/cm². Thus, a release agent dispersion solution is prepared in which a release agent (polyethylene wax) having a volume average particle diameter of 200 nm is dispersed.

(Production of toner primary particle)
<Production of toner primary particle (1)>
Aggregation step

| | | |
|---|---|---|
| resin particle dispersion solution (1) | 320 | parts |
| colorant dispersion solution (1) | 80 | parts |
| release agent particle dispersion solution | 96 | parts |
| ion-exchanged water | 1270 | parts |
| aluminum chloride (manufactured by Wako Pure Chemical | 1.5 | parts |
| Industries, Ltd.) | | |

The above-described materials are placed in a stainless steel circular flask, followed by dispersion using a homogenizer (Ultra Turrax T50, manufactured by IKA) at 5000 rpm for 5 minutes. Thereafter, the pH of the mixture in the container is adjusted to 2.8, and the mixture is then transferred to a flask. The mixture is allowed to stand while stirring at 25° C. for 20 minutes using four paddles. Thereafter, the mixture is heated in a heating oil bath to 48° C. with a heating rate of 1° C./min while stirring. The mixture is held at 48° C. for 20 minutes. Thereafter, 80 parts of the resin particle dispersion solution (1) are mildly added to the mixture. The resultant mixture is held at 48° C. for 40 minutes. Thereafter, 1N sodium hydroxide aqueous solution is added to the mixture to adjust the pH to 6.5.

Thereafter, the mixture is heated to 97° C. with a temperature increasing rate of 1° C./min, and is then held for 30 minutes. 0.1 N nitric acid aqueous solution is added to the mixture to adjust the pH to 4.5. The resultant mixture is allowed to stand at 97° C. for 2 hours. Thereafter, 1 N sodium hydroxide aqueous solution is added to the mixture to adjust the pH to 6.5, and the resultant mixture is allowed to stand at 97° C. for 5 hours. Thereafter, the mixture is cooled to 30° C. at a rate of 5° C./min.

The toner particle dispersion solution thus prepared is filtered. (A) 2,000 parts of ion-exchanged water (35° C.) is added to the resultant toner particle; (B) the mixture is allowed to stand while stirring; and (C) the mixture is then filtered. The operations of (A) to (C) are repeatedly performed 5 times. The toner particle on filter paper is transferred to a vacuum dryer and is then dried for 10 hours at 45° C. with 1,000 Pa or less. The reason why the pressure is set to be 1,000 Pa or less is that the toner particle contains water, and therefore, the water content is frozen at 45° C. in an initial stage of drying, and thereafter, the water content is sublimated, so that the internal pressure of the dryer is not constant during pressure reduction. Note that when drying is ended, the internal pressure is stable at 100 Pa. After the internal pressure of the dryer is returned to normal atmospheric pressure, the toner particle is removed. This is a toner primary particle (1).

The toner primary particle (1) thus obtained has an [S]/[C] of 0.0011 and a weight average molecular weight of 31,000.

<Production of Toner Primary Particle (2)>

A toner primary particle (2) is prepared under the same conditions as those of the toner primary particle (1), except that the colorant dispersion solution (2) is used instead of the colorant dispersion solution (1).

The toner primary particle (2) thus obtained has an [S]/[C] of 0.0011 and a weight average molecular weight of 31,000.

<Production of Toner Primary Particle (3)>

A toner primary particle (3) is prepared under the same conditions as those of the toner primary particle (1), except that the colorant dispersion solution (3) is used instead of the colorant dispersion solution (1).

The toner primary particle (3) thus obtained has an [S]/[C] of 0.0011 and a weight average molecular weight of 31,000.

<Production of Toner Primary Particle (4)>

A toner primary particle (4) is prepared under the same conditions as those of the toner primary particle (1), except that the colorant dispersion solution (4) is used instead of the colorant dispersion solution (1).

The toner primary particle (4) thus obtained has an [S]/[C] of 0.0011 and a weight average molecular weight of 31,000.

<Production of Toner Primary Particle (5)>

A toner primary particle (5) is prepared under the same conditions as those of the toner primary particle (1), except that the resin particle dispersion solution (2) is used instead of the resin particle dispersion solution (1).

The toner primary particle (5) thus obtained has an [S]/[C] of 0.0002 and a weight average molecular weight of 33,000.

<Production of Toner Primary Particle (6)>

A toner primary particle (6) is prepared under the same conditions as those of the toner primary particle (1), except that the resin particle dispersion solution (3) is used instead of the resin particle dispersion solution (1).

The toner primary particle (6) thus obtained has an [S]/[C] of 0.0030 and a weight average molecular weight of 28,000.

<Production of Toner Primary Particle (7)>

A toner primary particle (7) is prepared under the same conditions as those of the toner primary particle (1), except that the resin particle dispersion solution (4) is used instead of the resin particle dispersion solution (1).

The toner primary particle (7) thus obtained has an [S]/[C] of 0.0014 and a weight average molecular weight of 22,000.

<Production of Toner Primary Particle (8)>

A toner primary particle (8) is prepared under the same conditions as those of the toner primary particle (1), except that the resin particle dispersion solution (5) is used instead of the resin particle dispersion solution (1).

The toner primary particle (8) thus obtained has an [S]/[C] of 0.0010 and a weight average molecular weight of 39,000.

<Production of Toner Primary Particle (9)>

A toner primary particle (9) is prepared under the same conditions as those of the toner primary particle (1), except that the mixture of the materials of the toner primary particle (1) is held at 97° C. for 30 minutes; 0.1 N nitric acid aqueous solution is added to the mixture to adjust the pH to 4.2; the resultant mixture is allowed to stand at 97° C. for 4 hours; thereafter, 1 N nitric acid aqueous solution is added to the mixture to adjust the pH to 5.2; and the resultant mixture is allowed to stand at 97° C. for 8 hours.

The toner primary particle (9) thus obtained has an [S]/[C] of 0.0011 and a weight average molecular weight of 31,000.

<Production of Toner Primary Particle (10)>

A toner primary particle (10) is prepared under the same conditions as those of the toner primary particle (1), except that the mixture, of the materials of the toner primary particle (1) is held at 92° C. for 30 minutes; 0.1 N nitric acid aqueous solution is added to the mixture to adjust the pH to 5.2; the resultant mixture is allowed to stand at 92° C. for 2 hours; thereafter, 1 N nitric acid aqueous solution is added to the mixture to adjust the pH to 6.5; and the resultant mixture is allowed to stand at 92° C. for 5 hours.

The toner primary particle (10) thus obtained has an [S]/[C] of 0.0011 and a weight average molecular weight of 31,000.

<Production of Toner Primary Particle (11)>A toner primary particle (11) is prepared under the same conditions as those of the toner primary particle (1), except that the heating rate is changed from 1° C./min to 5° C./min.

The toner primary particle (11) thus obtained has an [S]/[C] of 0.0011 and a weight average molecular weight of 31,000.

<Production of Toner Primary Particle (12)>

A toner primary particle (12) is prepared under the same conditions as those of the toner primary particle (1), except that the amount of the release agent is changed from 96 parts to 23 parts, and the amount of the resin particle dispersion solution is changed from 320 parts to 365 parts.

The toner primary particle (12) thus obtained has an [S]/[C] of 0.0011 and a weight average molecular weight of 31,000.

<Production of Toner Primary Particle (13)>

A toner primary particle (13) is prepared under the same conditions as those of the toner primary particle (1), except that the amount of the release agent is changed from 96 parts to 182 parts, and the amount of the resin particle dispersion solution is changed from 320 parts to 266 parts.

The toner primary particle (13) thus obtained has an [S]/[C] of 0.0011 and a weight average molecular weight of 31,000.

<Production of Toner Primary Particle (14)>

A toner primary particle (14) is prepared under the same conditions as those of the toner primary particle (1), except that the resin particle dispersion solution (6) is used instead of the resin particle dispersion solution (1).

The toner primary particle (14) thus obtained has an [S]/[C] of 0.0001 and a weight average molecular weight of 30,000.

<Production of Toner Primary Particle (15)>

A toner primary particle (15) is prepared under the same conditions as those of the toner primary particle (1), except that the resin particle dispersion solution (7) is used instead of the resin particle dispersion solution (1).

The toner primary particle (15) thus obtained has an [S]/[C] of 0.0034 and a weight average molecular weight of 28,000.

<Production of Toner Primary Particle (16)>

A toner primary particle (16) is prepared under the same conditions as those of the toner primary particle (1), except that the resin particle dispersion solution (8) is used instead of the resin particle dispersion solution (1).

The toner primary particle (16) thus obtained has an [S]/[C] of 0.0013 and a weight average molecular weight of 18,000.

<Production of Toner Primary Particle (17)>

A toner primary particle (17) is prepared under the same conditions as those of the toner primary particle (1), except that the resin particle dispersion solution (9) is used instead of the resin particle dispersion solution (1).

The toner primary particle (17) thus obtained has an [S]/[C] of 0.0010 and a weight average molecular weight of 43,000.

The results of measurement of the [S]/[C] and weight average molecular weights of the toner primary particles (1) to (17) are shown in Table 1.

(Production of Toner for Development of Electrostatic Latent Image)

<Production of Toner for Development of Electrostatic Latent Image (1)>

1.0 parts of a resin particle (FS102, manufactured by Nippon Paint Co., Ltd., volume average particle diameter: 80 nm, weight average molecular weight: 330,000) and 2.0 parts of titanium oxide (T805, manufactured by Nippon Aerosil Co., Ltd., volume average particle diameter: 0.021 μm) are added to 100 parts of the toner primary particle (1), followed by mixing using a Henschel mixer at 3,000 rpm for 5 minutes. As a result, a toner for the development of an electrostatic latent image (1) is obtained.

The toner for the development of an electrostatic latent image (1) thus obtained had a volume average particle diameter of 5.7 μm, a shape factor SF1 of 122, and a GSDp of 1.21. The results are shown in Table 1.

<Production of Toners for Development of Electrostatic Latent Image (2) to (8)>

Toners for the development of an electrostatic latent image (2) to (8) are prepared under the same conditions as those of the toner for the development of an electrostatic latent image (1), except that the toner primary particles (2) to (8) are used instead of the toner primary particle (1). The results are shown in Table 1.

<Production of Toner for Development of Electrostatic Latent Image (9)>

A toner for the development of an electrostatic latent image (9) is prepared under the same conditions as those of the toner for the development of an electrostatic latent image (1), except that the resin particle (1) obtained from the resin particle dispersion solution (9) is used instead of FS102. The resultss are shown in Table 1.

<Production of Toner for Development of Electrostatic Latent Image (10)>

A toner for the development of an electrostatic latent image (10) is prepared under the same conditions as those of the toner for the development of an electrostatic latent image (1), except that MP-1451 (manufactured by Soken Chemical & Engineering Co., Ltd., Mw: 550,000) is used instead of FS102. The results are shown in Table 1.

<Production of Toner for Development of Electrostatic Latent Image (11)>

A toner for the development of an electrostatic latent image (11) is prepared under the same conditions as those of the toner for the development of an electrostatic latent image (1), except that the titanium oxide particle is not used. The results are shown in Table 1.

<Production of Toner for Development of Eelectrostatic Latent Image (12)>

A toner for the development of an electrostatic latent image (12) is prepared under the same conditions as those of the toner for the development of an electrostatic latent image (1), except that a silica particle (R812, manufactured by Nippon Aerosil Co., Ltd.) is used instead of the titanium oxide particle. The results are shown in Table 1.

<Production of Toner for Development of Electrostatic Latent Image (13)>

A toner for the development of an electrostatic latent image (13) is prepared under the same conditions as those of the toner for the development of an electrostatic latent image (1), except that an aluminum particle (AKP-50, manufactured by Sumitomo Chemical Co., Ltd.) is used instead of the titanium oxide particle. The results are shown in Table 1.

<Production of Toners for Development of Electrostatic Latent Image (14) to (22)>

Toners for the development of an electrostatic latent image (14) to (22) are prepared under the same conditions as those of the toner for the development of an electrostatic latent image (1), except that the toner primary particles (9) to (17) are used instead of the toner primary particle (1). The results are shown in Table 1.

The [S]/[C] of the toners for the development of an electrostatic latent image (1) to (22) is measured. The result is similar to that of the toner primary particles.

(Production of Electrostatic Latent Image Developer)

100 parts of a ferrite particle (manufactured by Powder-tech, volume average particle diameter: 50 μm) and 2.4 parts of styrene-methyl methacrylate copolymer resin (BR-52, manufactured by Mitsubishi Rayon Co., Ltd., molecular weight: 85,000) are placed along with 400 parts of toluene in a pressure kneader, followed by stirring and mixing at room temperature for 15 minutes. Thereafter, the temperature of the mixture is increased to 70° C. while mixing under reduced pressure. After toluene is removed by evaporation, the residue is cooled, followed by size classification using a 105-μm sieve. Thus, a ferrite carrier (resin-coated carrier) is obtained.

93 parts of the ferrite carrier is mixed with 7 parts of each of the toner for the development of an electrostatic latent image (1) to (22) to produce a dual-component electrostatic latent developer (1) to (22) having a toner concentration of 7% by weight.

### EXAMPLES

### Example 1

A modified version of DocuCentre Color 500 manufactured by Fuji Xerox Co., Ltd. (a fixing machine is detached) is used for evaluation. An image in the shape of a square with a side of 5 cm, on which a toner is placed on paper in an amount of 0.5 g/m² or 9.5 g/m², is prepared. Thus, an unfixed sample is produced. In this case, J paper manufactured by Fuji Xerox Co., Ltd. is used. The unfixed samples thus obtained are evaluated using an external fixing machine. The external fixing machine had the same heating roll and pressure roll as those of the fixing machine of DocuCentre Color 500. The contact width (nip width) between the heating roll and the pressure roll is fixed to 6 mm. The rotational speed and set temperature can be externally adjusted in the external fixing machine.

Note that the DocuCentre Color 500-modified machine is an image forming apparatus comprising an electrostatic latent image carrier; a portion for charging a surface of the electrostatic latent image carrier; a portion for forming an electrostatic latent image on a surface of the charged electrostatic latent image carrier; a developing apparatus which includes a developer comprising a toner and a carrier and develops the electrostatic latent image using a layer of the developer formed on a surface of a developer carrier to form a toner image on a surface of the electrostatic latent image carrier; a portion for transferring the toner image to an intermediate transfer member; and a cleaning portion using a cleaning blade.

The amounts of the two toners placed on paper are evaluated under the following conditions: process speed, 100 mm/s; and nip time (contact time of the fixing member), 0.06 sec. Note that the temperature of the heating roll is set at intervals of 10° C. over the temperature range of 100 to 220° C. The temperature of the pressure roll is set to be [the set temperature of the heating roll minus 10° C.].

Evaluation is performed as follows. Fixation is performed while increasing the set temperature from a low temperature. A temperature at which the cold offset disappears is defined as a lowest fixation temperature. A range from the lowest fixation temperature to [a temperature at which the hot offset occurs minus 10° C.] is defined as a fixation temperature region.

In the case of typical images, the amount of a toner varies even on the same image. Therefore, among samples on which different amounts of a toner are placed, the highest among the lowest fixation temperatures of the samples is defined as the lowest fixation temperature of the toner, and the lowest among the highest temperatures of the samples at which the hot offset occurs is defined as the temperature of the toner at which the hot offset occurs.

For example, it is assumed that a sample on which a toner is placed in an amount of 0. 5 g/m² has a lowest fixation temperature of 130° C. and a hot offset occurrence temperature of 180° C., and a sample on which a toner is placed in an amount of 9.5 g/m² has a lowest fixation temperature of 140° C. and a hot offset occurrence temperature of 20 0° C. In this case, the fixation temperature range is 30° C.

Fixation temperature regions of 70° C. or more, 60° C., 50° C., and 40° C. or less are represented by A, B, C, and D, respectively. The range of A and B are defined as being acceptable.

The results of fixation evaluation using the electrostatic latent image developer (1) are shown in Table 2.

### Example 2 to Example 18

Fixation is evaluated in the same manner as that of Example 1, except that the electrostatic latent image developers (2) to (18) of Table 2 are used. The results are shown in Table 2.

### Example 19 to Example 22

Fixation is evaluated in the same manner as that of Example 1, except that the electrostatic latent image developer (1) is used and the process speed is changed to that shown in Table 2. The results are shown in Table 2.

### Comparative Example 1 to Comparative Example 4

Fixation is evaluated in the same manner as that of Example 1, except that the electrostatic latent image developers (19) to (22) of Table 2 are used. The results are shown in Table 2.

According to the result of the fixation, the following will be clearly understood. When the toner of the present invention is used, a fixation temperature range of 60° C. or more can be secured irrespective of the process speed. In contrast, when the toner of the comparative example is used, the lowest fixation temperature can be secured, however, an offset occurs in a halftone portion, so that a fixation temperature region cannot be secured.

TABLE 1

| | | Resin | | | | | | | |
|---|---|---|---|---|---|---|---|---|---|
| | | particle | | | Weight | Volume | | | |
| Toner for | | weight | | | average | average | | | Amount |
| development of | Toner | average | Inorganic | | molecular | particle | | Shape | of |
| electrostatic | primary | molecular | particle | | weight | diameter | | factor | release |
| latent image | particle | weight | species | [S]/[C] | Mw | (μm) | GSDp | SF1 | agent |
| (1) | (1) | 330,000 | Titanium oxide | 0.0011 | 31,000 | 5.7 | 1.21 | 122 | 11.8 |
| (2) | (2) | 330,000 | Titanium oxide | 0.0011 | 31,000 | 5.6 | 1.22 | 121 | 12.0 |
| (3) | (3) | 330,000 | Titanium oxide | 0.0011 | 31,000 | 5.7 | 1.21 | 125 | 11.6 |
| (4) | (4) | 330,000 | Titanium oxide | 0.0011 | 31,000 | 5.8 | 1.20 | 123 | 12.1 |
| (5) | (5) | 330,000 | Titanium oxide | 0.0002 | 33,000 | 5.8 | 1.23 | 126 | 11.9 |
| (6) | (6) | 330,000 | Titanium oxide | 0.0030 | 28,000 | 5.5 | 1.22 | 121 | 11.5 |
| (7) | (7) | 330,000 | Titanium oxide | 0.0014 | 22,000 | 5.7 | 1.23 | 119 | 10.9 |
| (8) | (8) | 330,000 | Titanium oxide | 0.0010 | 39,000 | 5.5 | 1.22 | 128 | 12.1 |
| (9) | (1) | 43,000 | Titanium oxide | 0.0011 | 31,000 | 5.7 | 1.21 | 122 | 11.8 |
| (10) | (1) | 550,000 | Titanium oxide | 0.0011 | 31,000 | 5.7 | 1.21 | 122 | 11.8 |
| (11) | (1) | 330,000 | None | 0.0011 | 31,000 | 5.7 | 1.21 | 122 | 11.8 |
| (12) | (1) | 330,000 | Silica | 0.0011 | 31,000 | 5.7 | 1.21 | 122 | 11.8 |
| (13) | (1) | 330,000 | Aluminum oxide | 0.0011 | 31,000 | 5.7 | 1.21 | 122 | 11.8 |
| (14) | (9) | 330,000 | Titanium oxide | 0.0011 | 31,000 | 5.6 | 1.21 | 112 | 11.7 |
| (15) | (10) | 330,000 | Titanium oxide | 0.0011 | 31,000 | 5.5 | 1.21 | 135 | 11.6 |
| (16) | (11) | 330,000 | Titanium oxide | 0.0011 | 31,000 | 5.9 | 1.26 | 122 | 10.5 |
| (17) | (12) | 330,000 | Titanium oxide | 0.0011 | 31,000 | 5.4 | 1.20 | 121 | 2.9 |
| (18) | (13) | 330,000 | Titanium oxide | 0.0011 | 31,000 | 5.5 | 1.23 | 119 | 23.1 |
| (19) | (14) | 330,000 | Titanium oxide | 0.0001 | 30,000 | 5.6 | 1.21 | 122 | 11.8 |
| (20) | (15) | 330,000 | Titanium oxide | 0.0034 | 28,000 | 5.9 | 1.21 | 122 | 11.6 |
| (21) | (16) | 330,000 | Titanium oxide | 0.0013 | 18,000 | 5.5 | 1.21 | 122 | 12.2 |
| (22) | (17) | 330,000 | Titanium oxide | 0.0010 | 43,000 | 5.8 | 1.21 | 122 | 12.1 |

TABLE 2

| | | | | Lowest fixation | | Offset occurrence | | | |
|---|---|---|---|---|---|---|---|---|---|
| | | | | temperature (° C.) | | temperature (° C.) | | | |
| | Toner for | | Contact | Amount of | Amount of | Amount of | Amount of | | |
| | development of | | time of | placed | placed | placed | placed | Fixation | |
| | electrostatic | Process | fixing | toner | toner | toner | toner | temperature | |
| | latent image | speed | member | 0.5 g/m² | 9.5 g/m² | 0.5 g/m² | 9.5 g/m² | region (° C.) | Evaluation |
| Example 1 | (1) | 100 mm/s | 0.06 sec | 110 | 130 | 220 | 220 | 80 | A |
| Example 2 | (2) | 100 mm/s | 0.06 sec | 110 | 130 | 220 | 220 | 80 | A |
| Example 3 | (3) | 100 mm/s | 0.06 sec | 110 | 130 | 220 | 220 | 80 | A |
| Example 4 | (4) | 100 mm/s | 0.06 sec | 110 | 130 | 220 | 220 | 80 | A |
| Example 5 | (5) | 100 mm/s | 0.06 sec | 110 | 130 | 210 | 210 | 70 | A |
| Example 6 | (6) | 100 mm/s | 0.06 sec | 110 | 120 | 200 | 200 | 70 | A |
| Example 7 | (7) | 100 mm/s | 0.06 sec | 100 | 120 | 190 | 200 | 60 | B |
| Example 8 | (8) | 100 mm/s | 0.06 sec | 130 | 140 | 220 | 210 | 60 | B |
| Example 9 | (9) | 100 mm/s | 0.06 sec | 110 | 130 | 220 | 220 | 80 | A |
| Example 10 | (10) | 100 mm/s | 0.06 sec | 110 | 130 | 210 | 220 | 70 | A |
| Example 11 | (11) | 100 mm/s | 0.06 sec | 110 | 130 | 210 | 200 | 60 | B |
| Example 12 | (12) | 100 mm/s | 0.06 sec | 110 | 130 | 220 | 220 | 80 | A |
| Example 13 | (13) | 100 mm/s | 0.06 sec | 110 | 130 | 220 | 220 | 80 | A |
| Example 14 | (14) | 100 mm/s | 0.06 sec | 110 | 130 | 220 | 220 | 80 | A* |
| Example 15 | (15) | 100 mm/s | 0.06 sec | 110 | 130 | 220 | 220 | 80 | A** |
| Example 16 | (16) | 100 mm/s | 0.06 sec | 110 | 130 | 200 | 200 | 60 | B |
| Example 17 | (17) | 100 mm/s | 0.06 sec | 110 | 130 | 200 | 200 | 60 | B |
| Example 18 | (18) | 100 mm/s | 0.06 sec | 110 | 130 | 220 | 220 | 80 | A*** |
| Example 19 | (1) | 600 mm/s | 0.01 sec | 160 | 180 | 250 | 250 | 60 | B |
| Example 20 | (1) | 300 mm/s | 0.02 sec | 150 | 160 | 240 | 240 | 70 | A |
| Example 21 | (1) | 75 mm/s | 0.08 sec | 110 | 120 | 210 | 210 | 80 | A |
| Example 22 | (1) | 50 mm/s | 0.12 sec | 100 | 100 | 180 | 170 | 60 | B |
| Comparative | (19) | 100 mm/s | 0.06 sec | 120 | 130 | 180 | 190 | 40 | D |
| Example 1 | | | | | | | | | |
| Comparative | (20) | 100 mm/s | 0.06 sec | 110 | 120 | 170 | 190 | 40 | D |
| Example 2 | | | | | | | | | |
| Comparative | (21) | 100 mm/s | 0.06 sec | 100 | 120 | 160 | 170 | 30 | D |
| Example 3 | | | | | | | | | |
| Comparative | (22) | 100 mm/s | 0.06 sec | 130 | 150 | 200 | 200 | 40 | D |
| Example 4 | | | | | | | | | |

*Toner scattering is observed in the vicinity of a border between an image portion and a non-image portion.
**Nonuniform concentration due to transfer irregularities is observed in a half tone portion.
***A fog is observed in a non-image portion due to extension of a charge amount distribution.

According to the toner for the development of an electostatic latent image of the present invnetion, it is possible to secure a broad fixation temperature region. It is also possible to suppress offset in a halftone portion.

The entire disclosure of Japanese Patent Application No. 2004-341993 filed on Nov. 26, 2004 including specification, claims, drawings and abstract is incorporated herein by reference in its entirely.

What is claimed is:

1. A toner for development of an electostatic latent image, comprising:
a binder resin;
a colorant; and
a release agent,
wherein the binder resin has a weight average molecular weight of 20,000 to 40,000, and
when a carbon content and a sulfur content of the toner measured using X-ray fluorescence are represented by [C] % and [S] %, respectively, [S]/[C] satisfies expression (1):
0.0002≦[S]/[C]≦0.0030 (1)

2. The toner for development of an electrostatic latent image according to claim 1,
wherein the binder resin is obtained by polymerization of a vinyl polymerizable monomer.

3. The toner for development of an electrostatic latent image according to claim 1,
wherein the binder resin comprises a chain transfer agent, and the chain transfer agent comprises sulfer.

4. The toner for the development of an electrostatic latent image according to claim 1, further comprising an external additive on a surface of the toner,
wherein the external additive comprises a resin microparticle having a weight average molecular weight of 100,000 or more and 500,000 or less.

5. The toner for the development of an electrostatic latent image according to claim 1, further comprising an external additive on a surface of the toner,
wherein the external additive is at least one of silica, aluminium oxide and titanium oxide.

6. The toner for the development of an electrostatic latent image according to claim 1, further comprising an external additive on a surface of the toner,
wherein the external additive has a charge characteristic whose polarity is reverse to that of the toner.

7. The toner for the development of an electrostatic latent image according to claim 1, wherein the toner has a shape factor SF1 of 115 to 130.

8. The toner for the development of an electrostatic latent image according to claim 1, wherein the toner has a GSDp of 1.23 or less.

9. The toner for the development of an electrostatic latent image according to claim 1, wherein the toner has a release agent content of 5 to 20% by weight.

10. An electrostatic latent image developer comprising:
a carrier; and
the toner for the development of an electrostatic latent image according to claim 1.

11. The electrostatic latent image developer according to claim 10,
wherein the carrier comprises a resin-coating layer, and an electrically conductive fine powder is dispersed in the resin-coating layer.

12. The electrostatic latent image developer according to claim 10,
wherein the carrier has a volume average particle diameter of 10 to 100 μm

13. A method of forming an image, comprising:
charging a photoreceptor;
exposing the charged photoreceptor to create a latent image on the photoreceptor;
developing the latent image with a developer to create a developed image;
transferring the developed image onto a fixing base material; and
fixing the developed image on the fixing base material by heating using a fixing member,
wherein the developer is an electrostatic latent image developer according to claim 10.

14. The method of forming an image according to claim 13,
wherein, in the charging the photoreceptor, a contact charger is used.

15. The method of forming an image according to claim 13, wherein, in the transferring the developed image, a bias transfer roll comprising an elastic material is used.

16. The method of forming an image according to claim 13, wherein a time for which the fixing member contacts the toner on the fixing base material is 0.02 to 0.1 sec.
